(19) United States
(12) Patent Application Publication
(10) Pub. No.: US 2015/0081401 A1
(43) Pub. Date: Mar. 19, 2015

(54) CONTENT PROVIDER, A METHOD FOR DESIGNATING CONTENT COMPLIES WITH A STANDARD AND A SYSTEM FOR SHARING CONTENT

(71) Applicant: TeacherTube, LLC, Frisco, TX (US)

(72) Inventors: Mac Adam Smith, Frisco, TX (US); Loyd Jason Smith, Frisco, TX (US)

(73) Assignee: TeacherTube, LLC, Frisco, TX (US)

(21) Appl. No.: 14/026,797

(22) Filed: Sep. 13, 2013

(51) Int. Cl. G07C 13/00; G06F 17/30

(52) U.S. Cl. CPC G07C 13/00; G06F 17/30017
USPC 705/12; 707/736

(57) ABSTRACT

A system for sharing resources, a content provider and a method for indicating content complies with a recognized standard is provided herein. In one embodiment, the method includes: (1) receiving content from a member of a community of users, (2) receiving a designation input from the member that indicates the content aligns with a recognized standard associated with the community and the content; and (3) providing, for the community, the content with the recognized standard designated by the input.

### TECHNICAL FIELD

This disclosure relates to providing content for users and, more specifically, the relationship between content and recognized standards associated with the content.

### BACKGROUND

The Internet has provided a virtual worldwide stage for the presentation of videos. Various websites exist for people to upload and download videos for their entertainment. Videos and other types of media are also presented on various websites for other purposes than just entertainment. For example, instructional or educational videos can also be obtained for a variety of subjects.

### SUMMARY

In one aspect, the disclosure provides a method for indicating content complies with a recognized standard. In one embodiment, the method includes: (1) receiving content from a member of a community of users, (2) receiving a designation input from the member that indicates the content aligns with a recognized standard associated with the community and the content and (3) providing, for the community, the content with the recognized standard designated by the input.

In another aspect, the disclosure provides a content provider. In one embodiment, the content provider includes: (1) a processor, (2) a community interface configured to receive a designation input from a member of a community of users and votes from other members of the community that agree or disagree with the designation input and (3) a content manager configured to provisionally associate content with a recognized standard according to the designation input and permanently associate the content with the recognized standard based on the votes from the community.

In yet another aspect, the disclosure provides a system for sharing educational resources. In one embodiment the system includes: (1) a processor, (2) a community interface configured to receive a designation input from a member of an educational community and votes from other members of the educational community that agree or disagree with the designation input, wherein the designation input indicates an educational content aligns with an educational standard, (3) a content reservoir configured to store a plurality of educational resources uploaded by the educational community, including the educational content and (4) a content manager configured to provisionally associate the educational content with the educational standard according to the designation input and permanently associate the educational content with the educational standard based on the votes from the educational community.

### BRIEF DESCRIPTION

Reference is now made to the following descriptions taken in conjunction with the accompanying drawings, in which:

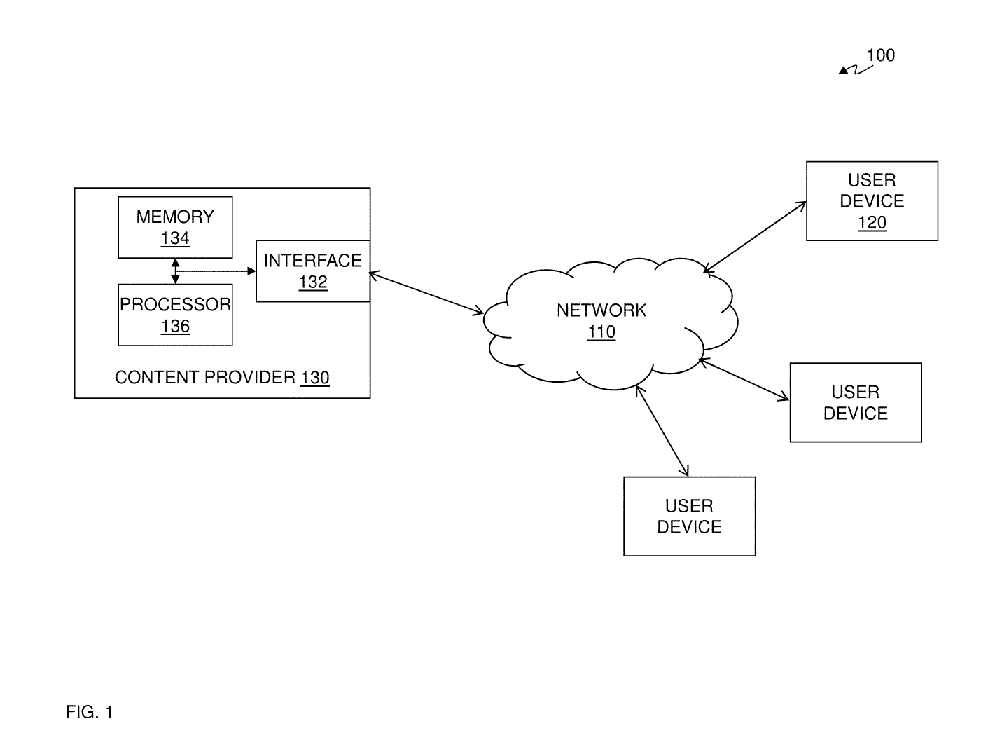

FIG. 1 illustrates a diagram of an embodiment of a content delivery system for sharing content constructed according to the principles of the disclosure;

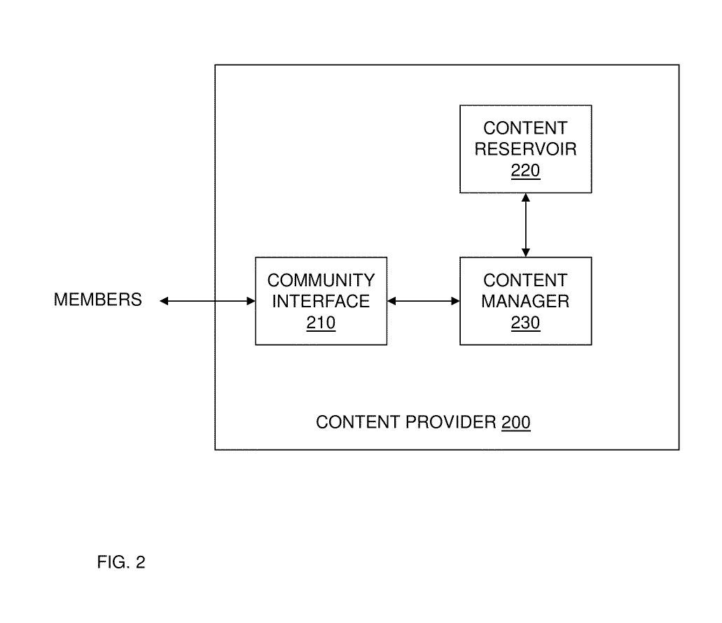

FIG. 2 illustrates a block diagram of an embodiment of a content provider constructed according to the principles of the disclosure;

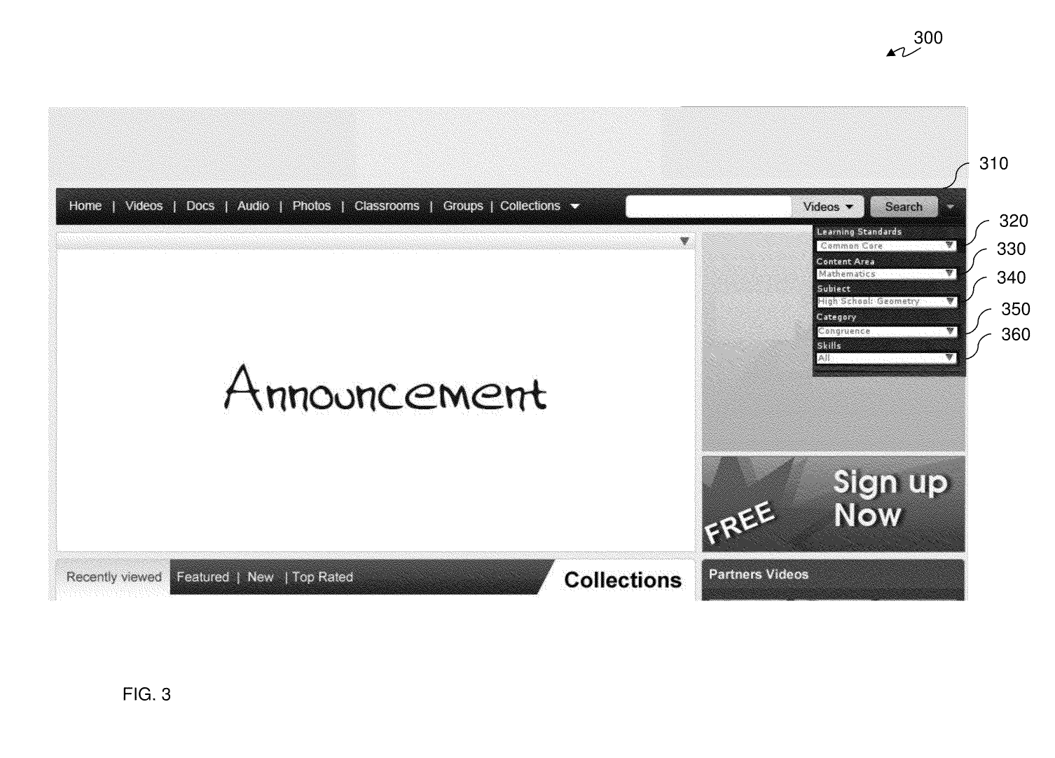

FIG. 3 illustrates a screen shot of an embodiment of an interface constructed according to the principles of the disclosure; and

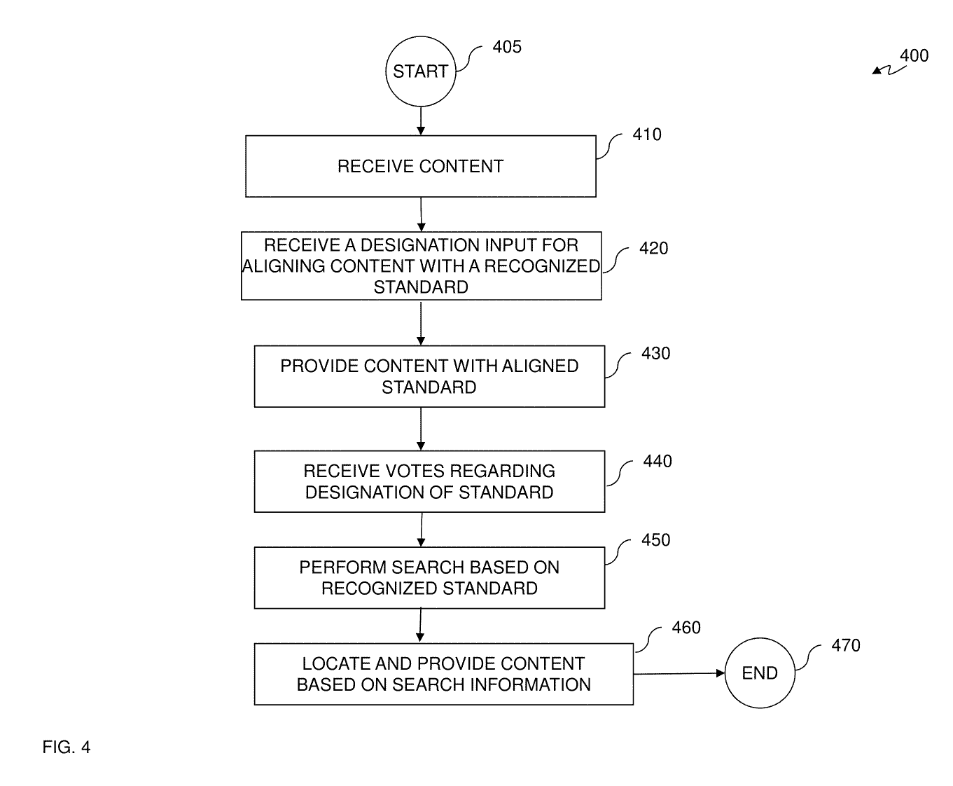

FIG. 4 illustrates a flow diagram of an embodiment of a method for indicating content complies with a recognized standard carried out according to the principles of the disclosure.

### DETAILED DESCRIPTION

Members of the educational industry, such as teachers, are taking advantage of these educational videos in the education process. Educators can download videos to assist them in teaching or even to help them understand a particular subject. Similarly, other users are also employing educational or instructional videos in their particular fields.

In education and other fields, different standards have been established and recognized. For education, these standards are often state based and can provide a desired level of learning for various grades. Unfortunately, the standards do not provide an approved list of educational videos that comply therewith. As such, locating educational videos that comply with the different standards can be difficult. This can also be true in other professions, industries, sports or areas of interest with different or progressive achievement levels that correspond to established or recognized standards. A recognized standard is a known standard established by a group, organization, committee, industry, etc., that provides a norm, level, measure or model, which can be used in comparative evaluations or analysis.

Accordingly, the disclosure provides a scheme for aligning videos and other types of media, referred to herein collectively as content, with recognized standards. A method, apparatus and system are also provided wherein users can share various types of content including documents, photographs, videos, graphics, audio files, maps and other types of media. Disclosed herein is a method, apparatus and system wherein a user can upload content and indicate that the content complies with a recognized standard. The user can be a member of a community of users associated together by a common interest, industry, organization, profession, etc. For example, the user can be a teacher of a community of teachers or a karate instructor of a community of karate instructors. In these two examples, the established standard can be an educational standard or requirements for the various levels of karate belts. The user and other members of the community can download the shared content. The shared content is typically created by the user or complies with copyright rules and regulations. Accordingly, the user has or has obtained permission to share the content.

After content has been designated to comply with a recognized standard, other members of the particular communities can then vote for or against the compliance assessment by the user. As such, a community of peers can confirm or deny the designated alignment of a video with a particular standard. In some embodiments, the original compliance indication is a provisional designation that is not made permanent until confirmed by a particular number of votes from the community. A community interface can visually or audibly indicate that the content has been approved for a particular standard and components of the standard.

In addition to aligning content with a recognized standard, the disclosure also provides embodiments for searching and locating content based on particular standards. As such a user can find a particular type of content that complies with a recognized standard and employ the content with confidence based on knowing their community of users has reviewed, assessed and aligned the content with an applicable standard recognized in the area. A user can obtain a group or collection of content, such as via searches, that are aligned with a recognized standard and direct others, such as students, to the grouped content for review. FIG. 3 illustrates an example of a community interface that can be used for access to the grouped content. Reviewing the content includes visibly reviewing, audibly reviewing and both visibly and audibly reviewing.

In some embodiments, aligning content with a recognized standard includes indicating the particular components of the recognized standard in which the content is aligned. Thus, the disclosure provides embodiments wherein a user can designate that shared content aligns with particular components of a recognized standard. The components can include parent-child related components wherein selection or indication of a parent component generates a list of child components for the selected parent component. In some embodiments, the child components are unique to a particular parent component. The components and the relationship between the components can be established by or within the recognized standard.

For example, the recognized standard can be from the Common Core State Standard Initiative (Common Core) that includes established components of “Content Area,” “Subject,” “Category” and “Skill Level.” The user can designate the Common Core Standard and then input the various options for each of the components. In some embodiments, the options can be dynamically provided by a drop down menu based on a previous selection of a parent component. Accordingly, a user can designate the “Content Area” of “English Language Arts” after the Common Core Standard is selected. Thereafter, the “Subject” of “Grade 8” can be selected. From this selection, the “Category” of “Speaking and Listening” can be selected. Thereafter, a particular skill, such as “SL.8.1” can be selected. Each of the above discussed components and options thereof are part of the recognized standard Common Core. One skilled in the art will understand that other types of recognized standards can also have components and particular options of divisions thereof. As with the skill level “SL.8.1,” a particular type of component can be a defined component that is defined by the governing or establishing body of the standard.

The United States Tennis Association (USTA) is an example of another recognized standard that has components for competition levels that include 3.0, 3.5, 4.0, etc. Associated with each of the components are skill levels that have been established for each of the competition levels. Thus, the features disclosed herein can be used to align tennis content with the different competition levels established by the USTA and even with a particular skill associated with one of the competition levels. As demonstrated by these examples, users can indicate not only compliance with a recognized standard but compliance with a particular part or component of the recognized standard and search for content based thereon.

Turning now to the figures, FIG. 1 illustrates a diagram of an embodiment of a content delivery system 100 constructed according to the principles of the disclosure. The content delivery system 100 is configured to allow a user to share content with a community of users and align the content with a standard that is recognized at least within the community. The content delivery system 100 also is configured to allow the community to agree or disagree with the asserted compliance by the user and to search for content based on recognized standards. The content delivery system 100 includes a network 110, user devices, wherein a representative user device is denoted 120, and a content provider 130.

The network 110 is configured to provide data communication between devices or components coupled thereto, such as the user devices and the content provider 130. The network 110 can be a conventional computer or communications network that allows the delivery of content between the user devices and the content provider 130. The network 110 can provide wireless connections, wired connections or a combination thereof. The network 110 can provide access to websites including websites of the World Wide Web. In one embodiment, the network 110 is the Internet.

The user device 120 is a computer device that is configured to communicate via the network 110. The user device 120 can be a conventional communication device such as a smart phone, a tablet, a pad, a laptop, a desktop, or another device capable of interfacing with a user and communicating via the network 110. The user devices can represent different users. As such, the illustrated user devices can represent a community of users. The multiple user devices can also represent different devices of a single user. User device 120 will be used to represent the other illustrated user devices.

The content provider 130 is configured to receive, store and deliver content. The content provider 130 is also configured to interface with users and allow users to designate that the content complies with a recognized standard. Accordingly, the content provider 130 is also configured to locate content aligned with a desired standard. As such, the content provider 130 is also configured to perform a search for content based on a particular standard and, more specifically, components of the standard.

In one embodiment, the content provider 130 is implemented on a server that includes the necessary logic and memory to perform the functions disclosed herein. Accordingly, the content provider 130 can be a website hosted on a web server, or servers, and that is accessible via the World Wide Web. A Uniform Resource Locator (URL) can be used to access the various webpages of the content provider 130. In some embodiments, a subscription or registry is required for access to the content provider 130. A member number or identification may be required for access. The content provider 130 includes an interface 132, a memory 134 and a processor 136.

The interface 132 is a component or device interface configured to couple the content provider 130 to the network 110 and communicate therewith. The interface 132 can be a conventional interface that communicates with the network 110 according to standard protocols. The interface 132 is configured to receive uploads of content from the user 120 and provide downloads of the content. Receiving and sending of the content can be performed according to conventional protocols. In addition to content, the interface 132 is also configured to transmit and receive data between the content provider and the user devices. For example, the interface 132 is configured to receive a designation input from a community member and votes from other members thereof that agree or disagree with the designation input. The designation input indicates the alignment of the educational content with an educational standard. At least a portion of the interface 132 can be a user interface provided on the user device 120 and employed as an interface between the content provider 130 and the user via the user device 120.

The memory 132 is configured to store the content. Additionally, the memory 132 is configured to store a series of operating instructions that direct the operation of the processor 136 when initiated. The memory 132 is a non-transitory computer readable medium. The memory 132 can be the memory of a server.

The processor 136 is configured to direct the operation of the content provider 130. As such, the processor 136 includes the necessary logic to communicate with the interface 132 and the memory 134 and perform the functions described herein including aligning, searching, directing uploads and downloads, and confirming. The processor 136 can be part of a server.

FIG. 2 illustrates a block diagram of an embodiment of a content provider 200 constructed according to the principles of the disclosure. The content provider 200 or at least a portion thereof can be embodied as a series of operating instructions stored on a non-transitory computer-readable medium that direct the operation of a processor when initiated. The content provider 200 can be stored on a single computer or on multiple computers. The various components of the content provider 200 can communicate via wireless or wired conventional connections. A portion of the content provider 200 can be located on a server and other portions of the content provider 200 can be located on a computing device or devices that are connected to the server via a network or networks. The content provider 200 can be configured to perform the various functions disclosed herein including aligning, searching, directing uploads and downloads, and confirming. In one embodiment, at least a portion of the content provider 200 is a computer program product. The content provider 200 includes a community interface 210, a content reservoir 220 and a content manager 230.

The community interface 210 is configured to provide an interface, including a visual and an audio interface, between a user or users of a community and the content provider 200. The community interface 210 is configured to receive inputs from community users that designate content alignment with standards and direct the sharing of content. The community interface 210 or at least a portion thereof can be provided on a display or screen of user devices such as user device 120 of FIG. 1 to allow interaction between users and the content provider 200. In some embodiments, the community interface 210 or at least a portion thereof includes at least some of the functionality of the interface 110 in FIG. 1. In one embodiment, the community interface 210 includes a web page provided on a user device. The interaction via the community interface 210 includes receiving a designation input from a member of a community with respect to the content and votes from other members of the community that agree or disagree with the designation input. The designation input indicates the content aligns with a recognized standard associated with the community and content. In some embodiment, the community interface 210 is also configured to receive content for uploads provide content for downloads.

The content reservoir 220 is configured to store a plurality of content uploaded by the community. The content reservoir 220 can be a conventional memory that is configured to store the content. The content reservoir 220 can be a searchable database wherein the content is searchable via recognized standards and components within the recognized standard. The content reservoir 220 can include tables that provide an index for searching the content. The content reservoir 220 can be implemented on a memory such as the memory 134 of FIG. 1.

The content manager 230 is configured to provisionally associate content with a recognized standard according to a designation input. Additionally, the content manager 230 is configured to permanently associate content with the recognized standard based on votes from the community. The content manager 230 is further configured to search the content reservoir 220 according to a selected recognized standard and according to components of the selected recognized standard. In some embodiments, the content manager 230 is configured to generate a group of content aligned with a recognized standard per directions from a user via the community interface 210. A community member or others who have been given permission can then access the grouped content via the community interface 210. In some embodiments, the content provider 200 has different access levels with the community of members and for non-members.

The content provider 200 can be used with various types of content and, accordingly, with various recognized standards. Some recognized standards mentioned herein include Common Core, USIA and martial arts (karate). The content provider 200 can also be used with recognized standards for films such as determined by the Motion Picture Association of America (MPAA). Thus, shared videos or other content can be rated by a user and confirmed by a community according to the MPAA ratings.

FIG. 3 illustrates an embodiment of a community interface 300 constructed according to the principles of the disclosure. The community interface 300 is for the embodiment in which a content provider can be employed with educational content and standards. The community interface 300 is a graphical user interface that can be provided on a user device to provide information to and receive inputs from a user or users. In one embodiment, the community interface 300 is a web page that can be accessed by a user device. The community interface 300 includes elements that are not pertinent to this embodiment and will not be discussed herein for simplicity. One skilled in the art will also understand that a community interface can include multiple pages. The multiple pages can include access to grouped content. Tabs of the community interface 300 can be used to go to the other pages.

The community interface 300 includes a search button 310 that is configured to initiate a search for stored content when activated. The search button 310 includes a down arrow that initiates the presentation of a standard or standards to select for the search. Activation of the search down arrow provides different areas on the interface 300 for selection of the standard and components thereof. The standards and components that are provided for the search correspond to the standards and components in which content can be aligned with when uploaded. The down arrows in each area initiate a list that is provided for the user. Therefrom, the user can select. The components are dynamic with respect to the selection of a parent component. The areas include: a learning standard 320, a content area 330, a subject 340, a category 350 and a skills 360.

The learning standard 320 provides the associated recognized standards for educational content. In FIG. 3, Common Core has been selected. An example of another educational standard is Texas Essential Knowledge and Skills (TEKS). A selection of this standard would result in different options for the various components.

The content area 330 indicates a selection of Mathematics. Within the area of Mathematics, the subject 340 of High School Geometry is selected. The exciting topic of Congruence is then selected for the category 350 and a skill level of All for the skills 360. Thus, a user does not have to restrict a component to a particular option but can select All for one, multiple or for each of the component selections for a standard. A similar drop down menu can be provided by the community interface 300 for a user to designate alignment of content when uploading. The various components listed can mirror the designated components of a recognized standard. In some embodiments, instead of drop down menus, selections can be received via direct entry.

Turning now to FIG. 4, an embodiment of a method for customizing recognized percentages of segments that constitute a collection of assets is illustrated. In one embodiment, at least a portion of the method 400 can be performed by a content provided as disclosed herein. A computing device may include the necessary logic circuitry to carry out the method 400. In one embodiment, the method 400 or at least a portion thereof may be embodied as a series of operating instructions that are stored on a non-transitory computer readable medium and used to direct the operation of a processor when initiated thereby. The method 400 begins in a step 405.

In a step 410, content from a member of a community of users is received. The content may be received via an upload employing a network. One skilled in the art understands uploading content.

A designation input from the member is received that indicates the content aligns with a recognized standard associated with the community and the content in a step 420 of the method 400. The designation input can be received via community interface. In one embodiment, a selectable list of recognized standards that includes the recognized standard is provided for the user to assist the user in entering the designation input.

In a step 430, the content is provided for review to the community with the recognized standard designated by the designation input. Access to the content can be provided via a community interface.

In a step 440, votes indicating agreement or disagreement that the content complies with the recognized standard are received. The votes can be received via a community interface after community members review the content. In one embodiment, selectable voting options for indicating agreement or disagreement are provided to the community. In some embodiments, a difference of at least 31 votes in agreement versus disagreement is needed to confirm the designated alignment. Similarly, a difference of at least 31 votes in disagreement versus agreement is needed to indicate the alignment is incorrect. In some embodiments, another type of algorithm may be used determine agreement or disagreement. If confirmed, the alignment can be made permanent. If not confirmed, the compliance designation is removed. Community members can also expand the designated alignment with a standard to a different recognized standard or for different components of the recognized standard. As such, members of the community can agree with the user and indicate additional alignment. The expanded alignment is then voted on as described herein.

In a step 450, a search is performed for the content based on the recognized standard. In a step 460, the content is located and provided based on the search information. The method 400 ends in a step 470.

A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

1. A method for indicating content complies with a recognized standard, comprising:
receiving content from a member of a community of users;
receiving a designation input from said member that indicates said content aligns with a recognized standard associated with said community and said content; and
providing, for said community, said content with said recognized standard designated by said input.

2. The method as recited in claim 1 further comprising receiving votes indicating agreement or disagreement that said content complies with said recognized standard.

3. The method as recited in claim 2 further comprising confirming compliance of said content with said recognized standard based on said votes and indicating to said community said compliance with said content.

4. The method as recited in claim 3 wherein said confirming is based on a predetermined value representing the difference between a number of said votes indicating said agreement and said disagreement.

5. The method as recited in claim 1 wherein said receiving said content includes receiving said content via an upload over a computer network.

6. The method as recited in claim 1 further comprising providing to said member a selectable list of recognized standards that includes said recognized standard.

7. The method as recited in claim 1 further comprising providing to said community selectable voting options for indicating said agreement or said disagreement.

8. The method as recited in claim 1 further comprising performing a search for said content based on said recognized standard.

9. The method as recited in claim 8 further comprising locating and providing said content based on said search.

10. The method as recited in claim 1 further comprising receiving additional designation input from another member of said community that indicates said content aligns with a different recognized standard or different components of said recognized standard.

11. The method as recited in claim 1 wherein said content is a video, a photograph, a document or an audio recording.

12. The method as recited in claim 1 wherein said recognized standard is selected from the group of standards consisting of:
an educational standard,
a film standard, and
a sports standard.

13. A content provider, comprising:
a processor;
a community interface configured to receive a designation input from a member of a community of users and votes from other members of said community that agree or disagree with said designation input; and
a content manager configured to provisionally associate content with a recognized standard according to said designation input and permanently associate said content with said recognized standard based on said votes from said community.

14. The content provider as recited in claim 13 further comprising a visual interface that includes a list of recognized standards for selection and aligning with said content.

15. The content provider as recited in claim 13 wherein said designation input is an original designation input for said content that indicates said content aligns with said recognized standard.

16. The content provider as recited in claim 13 wherein said community interface is further configured to receive uploads of said content and provide downloads of said content.

17. The content provider as recited in claim 13 wherein said content manager is further configured to perform a search for said content based on said recognized standard.

18. A system for sharing educational resources, comprising:
a processor;
a community interface configured to receive a designation input from a member of an educational community and votes from other members of said educational community that agree or disagree with said designation input, wherein said designation input indicates an educational content aligns with an educational standard;
a content reservoir configured to store a plurality of educational resources uploaded by said educational community, including said educational content; and
a content manager configured to provisionally associate said educational content with said educational standard according to said designation input and permanently associate said educational content with said educational standard based on said votes from said educational community.

19. The system as recited in claim 18 wherein said content manager is further configured to search said content reservoir according to a selected educational standard.

20. The system as recited in claim 19 wherein said content manager is further configured to search said content reservoir based on a subject, a category and a skill level.
